(19) United States
(12) Patent Application Publication
(10) Pub. No.: US 2022/0153626 A1
(43) Pub. Date: May 19, 2022

(54) DOPED FUSED SILICA COMPONENT FOR USE IN A PLASMA-ASSISTED MANUFACTURING PROCESS AND METHOD FOR PRODUCING THE COMPONENT

(71) Applicant: Heraeus Quarzglas GmbH & Co. KG, Hanau (DE)

(72) Inventors: Mark STAMMINGER, Hanau (DE); Mario SUCH, Hanau (DE)

(73) Assignee: Heraeus Quarzglas GmbH & Co. KG, Hanau (DE)

(21) Appl. No.: 17/438,698

(22) PCT Filed: Feb. 27, 2020
(86) PCT No.: PCT/EP2020/055116

§ 371 Date: Sep. 13, 2021

(30) Foreign Application Priority Data
Mar. 13, 2019 (EP) 19162613.4

(51) Int. Cl. C03C 3/06; C03B 19/06

(52) U.S. Cl. CPC C03C 3/06; C03C 2201/12; C03B 19/066

(57) ABSTRACT

Doped quartz glass components for use in a plasma-assisted manufacturing process contain at least one dopant which is capable of reacting with fluorine to form a fluoride compound, and the fluoride compound has a boiling point higher than that of SiF₄. The doped quartz glass component has high dry-etch resistance and low particle formation, and has uniform etch removal when used in a plasma-assisted manufacturing process. The doped quartz glass has a microhomogeneity defined by (a) a surface roughness with an Rₐ value of less than 20 nm after the surface has been subjected to a dry-etching procedure as specified in the description, or (b) a dopant distribution with a lateral concentration profile in which maxima of the dopant concentration are at an average distance apart of less than 30 μm.

### TECHNICAL FIELD

The invention relates to a doped quartz glass component for use in a plasma-assisted manufacturing process, in particular in semiconductor manufacture, containing at least one dopant which is capable of reacting with fluorine to form a fluoride compound, wherein the fluoride compound has a boiling point higher than that of SiF₄.

In addition, the invention relates to a method of producing a doped quartz glass component for use in a plasma-assisted manufacturing process, comprising the following method steps:
(a) providing a slip containing SiO₂ particles in an aqueous liquid,
(b) providing a doping solution containing a solvent and at least one dopant or a starting substance for the at least one dopant in dissolved form,
(c) bringing together doping solution and slip to form a dispersion, in which particles containing the dopant or a dopant precursor substance are precipitated,
(d) drying the dispersion to form granular particles containing SiO₂ and the dopant or the dopant precursor substance, and
(e) sintering or fusing the granular particles to form the doped quartz glass component.

Plasma-assisted dry etching—also known as “plasma etching” for short—is an essential technology for producing ultrafine structures of semiconductor components, high-resolution displays and in solar cell manufacture.

Plasma etching is performed in a vacuum reactor at a relatively high temperature and in a highly corrosive atmosphere. The vacuum reactor is generally flushed with an etching gas at low pressure. By a high-frequency discharge between electrodes or by an electrodeless microwave discharge, a highly reactive etching plasma is generated.

Halogen-containing etching gases, for example, in particular perfluorinated hydrocarbons such as e.g. CF₄, CHF₃, C₂F₆, C₃F₈, NF₃ or SF₆, are used for etching silicon-based structures. Elemental fluorine, fluorine ions and fluorine radicals not only display the desired etching action but also react with other components that are exposed to the plasma. The corrosive wear that this causes can lead to particle generation and to a marked change in the component, requiring this to be replaced. This particularly affects the reactor wall and walls of reactor inserts, such as wafer holders, heating devices, pedestal and supporting or clamping elements, that are close to the object being treated (which, for the sake of simplicity, will also be referred to below as the “wafer” for short).

### BACKGROUND ART

Because of its high chemical resistance to many substances used in the manufacturing process, and its relatively high heat resistance, quartz glass is often used for components that are subject to particular stress. In the case of fluorine-containing etching gas, however, the SiO₂ of the quartz glass undergoes a reaction with reactive fluorine to form SiF₄. The boiling point of SiF₄ is −86° C., and so this compound readily passes into the gas phase, accompanied by marked corrosion on the surface of the quartz glass.

It is known that an improvement in the dry-etch resistance of quartz glass can be achieved by doping with other substances. Thus, for example, U.S. Pat. No. 6,887,576 B2 discloses that a high dry-etch resistance of quartz glass is achievable by doping with metallic elements if the metallic element is capable of reacting with fluorine to form a fluoride compound having a boiling point higher than that of SiF₄. The following are mentioned as examples of these metallic elements: Al, Sm, Eu, Yb, Pm, Pr, Nd, Ce, Tb, Gd, Ba, Mg, Y, Tm, Dy, Ho, Er, Cd, Co, Cr, Cs, Zr, In, Cu, Fe, Bi, Ga, and Ti.

For producing the plasma-etch-resistant quartz glass, a plurality of methods are mentioned. In one of them, an aqueous slip is prepared, composed of 750 g quartz powder comprising particles with particle diameters of 100 to 500 μm, 200 g SiO₂ powder composed of pyrolytically produced silicon dioxide, and 700 g aluminium nitrate. The slip is dried slowly to form a solid and then subjected to a thermal treatment at 1800° C. under vacuum. As a result, transparent quartz glass doped with 2.0 wt. % Al₂O₃ is obtained.

With some of the known dopants, however, a significant improvement in dry-etch resistance requires a high dopant concentration, which can lead to precipitations, phase separation and crystallisation.

To avoid this, US 2005/0272588 A1 proposes a co-doping of rare earth metal and aluminium oxide, with a range of 0.1 to 20 wt. % being given for the total dopant concentration. To produce an accordingly doped quartz glass blank, SiO₂ powder is mixed with powdered oxides of the dopants, and the mixture is sintered in a quartz glass tube under reduced pressure.

In US 2008/0066497 A1, a wafer holder composed of a quartz glass doped with 1.5 wt. % Al₂O₃ and nitrogen is described for use in dry-etching processes. The Al₂O₃ doping is produced in a Verneuil method by melting a mixture of SiO₂ powder and Al₂O₃ powder.

DE 10 2012 012 524 B3 describes the production of a Yb₂O₃ and Al₂O₃-doped quartz glass via a slip route. The slip contains SiO₂ particles in the form of SiO₂ aggregates composed of nanoparticles having an average particle size of approximately 10 μm, and is adjusted to a pH value of 14. An aqueous doping solution with dissolved AlCl₃ and YbCl₃ is supplied to the slip by spray mist. The high pH value of the suspension leads to an immediate coprecipitation of hydroxides in the form of Al(OH)₃ and Yb(OH)₃. The dopant concentration is set at 1 mole % Al₂O₃ and 0.25 mole % Yb₂O₃ (based on the SiO₂ content of the suspension). The doped SiO₂ slip is further processed into a granular material, from which a doped quartz glass component is produced.

US 2018/0282196 A1 describes the production of a laser-active quartz glass doped with rare earth metals or transition metals starting from an aqueous slip.

After granulation, the still porous doped SiO₂ granular material is put into a graphite mould and vitrified by gas pressure sintering.

### Technical Problem

In previously known doped quartz glass materials for applications in process environments of reactive plasma dry-etching technology, plasma resistance proves to be of low reproducibility.

Furthermore, in semiconductor manufacturing processes, such as for instance sputtering or vapour deposition processes, the problem often occurs that material layers are deposited on the surfaces inside the reactor. The material layers can become detached over time and then also lead to particle problems. The material layers adhere better to rough component surfaces, and so the surface roughness of the particular component plays an important part. However, it is difficult to take proper account of the parameter of “surface roughness” if this changes constantly over the lifetime of the component as a result of etch removal.

The invention is therefore based on the object of providing a doped quartz glass component which is distinguished by high dry-etch resistance and low particle formation and in particular by uniform etch removal when used in a plasma-assisted manufacturing process.

The invention further concerns the provision of a method of producing such a component.

### SUMMARY OF THE INVENTION

With regard to the method, starting from a method of the type mentioned above, this object is achieved according to the invention by the fact that the SiO₂ particles in the slip are aggregates or agglomerates of SiO₂ primary particles and have an average particle size of less than 30 μm.

These SiO₂ particles are preferably produced pyrogenically with the aid of a soot deposition process. Here, a liquid or gaseous starting substance undergoes a chemical reaction (hydrolysis or pyrolysis) and is deposited from the gas phase on to a deposition surface as solid SiO₂. The reaction zone is e.g. a burner flame or an arc (plasma). Synthetic quartz glass is produced on an industrial scale by these plasma deposition or CVD processes, which are known e.g. as OVD, VAD, MCVD, PCVD or FCVD processes. The starting substance is e.g. silicon tetrachloride (SiCl₄) or a chlorine-free silicon compound, such as a polyalkylsiloxane.

The SiO₂ primary particles formed in the reaction zone are spherical and have particle sizes averaging less than 200 nm, typically even less than 100 nm. In the reaction zone, these spherical nanoparticles join together to form secondary particles in the form of more or less spherical aggregates or agglomerates, which are deposited on the deposition surface as porous “carbon black” (often also known as “soot”), accruing as so-called “soot bodies” or “soot dust”. Depending on the location where they originate within the reaction zone and their route to the deposition surface, the secondary particles consist of different numbers of primary particles and therefore always display a broad particle size distribution.

The soot deposition process produces an isotropic SiO₂ mass distribution in the “soot body” or “soot dust”, which is advantageous for a homogeneous dopant distribution.

The “secondary particles” that have been pyrogenically produced in this way will be referred to below as “SiO₂ particles”. An aqueous slip is produced, which contains these SiO₂ particles with an average particle size of less than 30 μm, preferably of less than 20 μm and most particularly preferably of less than 15 μm.

The slip is adjusted to an alkaline pH value, e.g. to a pH value greater than 12, in particular to a pH value of 14, and is homogenised.

In addition, a doping solution is prepared, which contains a solvent and at least one dopant. The dopant or a dopant precursor substance is soluble in the solvent. In the case of a dopant in the form of aluminium (Al), the solvent is e.g. water and the soluble precursor substance for the dopant is e.g. AlCl₃. Instead of chlorides, other soluble compounds, such as e.g. nitrates or organic compounds, can be used as the precursor substance.

The doping solution is supplied to the slip. This preferably takes place by continuously agitating, e.g. vibrating, shaking or stirring, the slip and supplying the doping solution to the agitated slip slowly and in finely divided form, e.g. in the form of a spray mist in which the doping solution is present in atomised form. The spray mist is produced e.g. by supplying the doping solution under pressure to an atomising nozzle and accelerating it out of this atomising nozzle towards the slip surface in the form of fine droplets. The fine droplets have diameters of e.g. between 10 μm and 40 μm.

Because of the high pH value of the slip, immediate precipitation of the hydroxide of the dopant occurs, e.g. in the form of Al(OH)₃. The hydroxide solid adsorbs on the surfaces of the SiO₂ particles in the slip and is thereby immobilised, such that a coagulation, segregation or sedimentation of hydroxide particles is prevented. The slip to which the dopant has been added is further homogenised.

The dopant or dopant precursor substance settles on the surfaces of the SiO₂ particles and, since the SiO₂ particles are not fully dense, it may be assumed that dopant also passes into the SiO₂ particles, being distributed into the cavities between the SiO₂ primary particles. This procedure ensures that the dopant or dopant precursor substance is distributed as homogeneously as possible in and on the SiO₂ solids portion of the slip. The slip therefore preferably contains exclusively pyrogenically produced SiO₂ particles.

The SiO₂ slip to which the dopant has been added is then dried by conventional means and further processed into porous granular particles, which contain SiO₂ and the at least one dopant. From the granular particles, the doped, transparent quartz glass component is sintered or fused.

The sintering of the granular particles preferably takes place in a nitrogen-containing atmosphere by gas pressure sintering. During sintering, a complete melting of the granular particles is avoided, such that little or no liquid phase is obtained and the long-range order predefined by the arrangement of the granular particles is substantially maintained after sintering—apart from the compactions typical of sintering resulting from particle rearrangements and diffusion-driven material transport. Since the surfaces of the original SiO₂ particles of the slip are occupied homogeneously with the dopant, and since these particles are not significantly altered by the sintering, the initial size of the SiO₂ particles is crucial for the local distribution of the dopant. Thus, the low initial average particle size of the SiO₂ particles, together with the way in which the doping is produced, contributes to a high microhomogeneity of the dopant distribution and thus to a high dry-etch resistance, low particle formation and uniform etch removal.

With regard to the component, the technical object stated above is achieved according to the invention, starting from a component of the type mentioned above, by the fact that the doped quartz glass has a microhomogeneity defined by (a) a surface roughness with an Rₐ value of less than 20 nm after the surface has been subjected to a dry-etching procedure as specified in the description, and/or (b) a dopant distribution with a lateral concentration profile in which maxima of the dopant concentration are at an average distance apart of less than 30 μm.

The quartz glass component according to the invention consists of quartz glass with a dopant or with a plurality of dopants, and is distinguished by a comparatively homogeneous dopant distribution on a micro scale. The surface roughness displayed by the doped quartz glass after a standardised dry-etching procedure, and/or the average distance between maxima of the dopant concentration, serve(s) as a measure of the homogeneous dopant distribution.

The term “lateral” implies a two-dimensional concentration profile along a direction—in contrast to a spatial concentration profile over an area.

Surprisingly, it has been shown that a homogeneous dopant distribution on a micro scale increases the dry-etch resistance of the component as well as reducing the roughness of the surface after the dry-etching treatment. When the doped quartz glass component is used in a plasma-assisted manufacturing process, its high microhomogeneity counteracts a rapid increase in surface roughness and thus, at the same time, slows down the dry-etching rate.

The roughness of the surface treated using the standardised dry-etching procedure is distinguished by a low roughness depth with an Rₐ value of less than 20 nm, and ideally an Rₐ value of less than 15 nm.

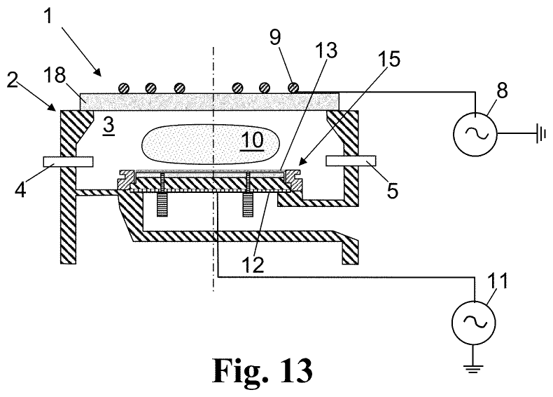

FIG. 13 is a schematic diagram of a plasma reactor 1 for carrying out a dry-etching treatment of a test sample 13. The reactor 1 has a wall 2, which surrounds a plasma reactor chamber 3. The wall 2 is provided with a gas inlet 4, which is connected to a gas source (not illustrated), from which gases can be supplied to the reactor chamber 3. Via a gas outlet 5, which is connected to a high vacuum pump (not illustrated), the chamber interior 3 is pumped out to establish a low chamber pressure of between 0.5 and 10 Pa which is suitable for the dry-etching treatment. A 13.56 MHz high-frequency power source 8, which is connected to an upper electrode 9, inductively couples energy into a plasma 10 that has been ignited inside the reactor chamber 3. A further 13.56 MHz high-frequency power source 11 is connected to a lower electrode 12, which is positioned below the test sample 13 to be treated and by means of which an independent electrical bias voltage can be applied to the test sample 13. The test sample 13 is held on a holding device, which is given the overall reference sign 15. The upper closure of the reactor wall 2 is formed by a dielectric window 18.

To determine the microhomogeneity, the test sample is subjected to a standard dry-etching procedure with the following treatment steps:
(a) A flat side of a quartz glass disc with a round cross-section having a diameter of 28 mm and a thickness of 1 mm is polished such that it has a surface roughness with an Rₐ value of 4 nm or less.
(b) The quartz glass disc is introduced into the plasma reactor 1 and the polished flat side is subjected to a dry-etching procedure, which is characterised by the following parameters:
   A power of 600 watts is supplied to the high-frequency power source 8.
   A bias voltage of minus 100 volts is applied to the test sample at an input power of 10 watts by means of the high-frequency power source 11.
   The following process gases are introduced into the reactor chamber 3 through the gas inlet 4: 5 sccm argon, 1 sccm CF₄, 0.3 sccm O₂.
   The chamber pressure is set at 6 Pa.
   The etching period is 60 minutes.

It has been shown that, after this dry-etching procedure, a surface roughness is obtained which is a measure of the homogeneity of the dopant distribution in the sample. This can be attributed to the fact that dopant-rich quartz glass regions display different dry-etching characteristics compared to dopant-poor quartz glass regions. In principle, the dopant-rich quartz glass regions should have a comparatively low etch rate. During the etching period of 60 minutes, even small differences in the etch rates become noticeable and cause the roughening of the etched surface. In the component according to the invention, however, the differences in etch rates are so small that an average surface roughness (Rₐ value) of less than 20 nm, preferably less than 15 nm, is obtained. This low surface roughness therefore indicates a high homogeneity of the dopant distribution.

The high homogeneity of the dopant distribution is also shown by the fact that, when the concentration profile of the at least one dopant is measured in a lateral direction, maxima of the dopant concentration are determined which are at a small distance apart. Preferably, therefore, the doped quartz glass has a microhomogeneity defined by a dopant distribution with a lateral concentration profile in which maxima of the dopant concentration are at an average distance apart of less than 30 μm, preferably a distance of less than 20 μm and particularly preferably less than 15 μm.

The lateral concentration profile of the at least one dopant is determined by spatially resolved analysis, e.g. by energy-dispersive X-ray spectroscopy (EDX). The distance is obtained as the centre-to-centre distance between adjacent concentration maxima; the average distance is the arithmetic mean of a plurality of measurements.

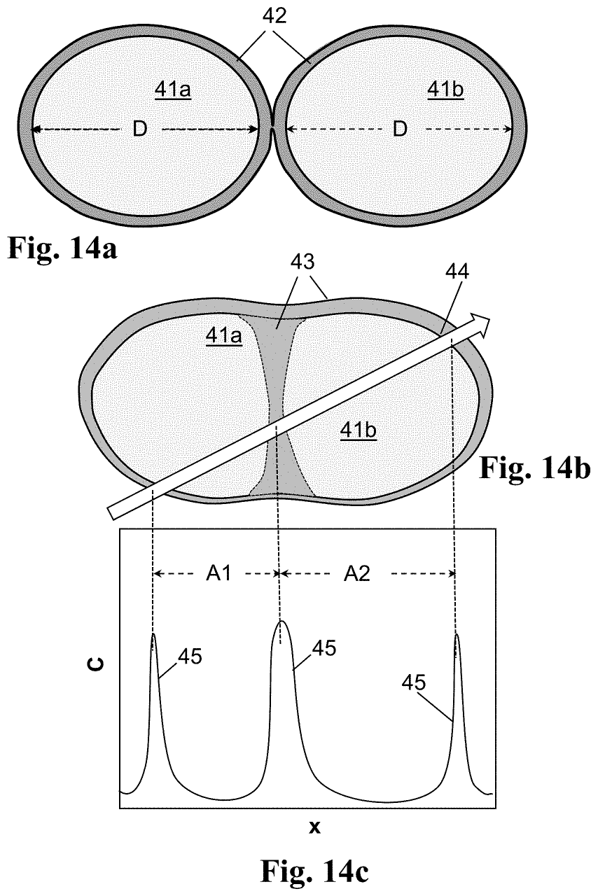

The determination of the lateral dopant concentration profile will be explained with the aid of FIGS. 14a to 14c. The sketch of FIG. 14a shows two adjacent SiO₂ particles 41a, 41b, the surfaces of which are each coated with a layer 42 of a dopant. The SiO₂ particles have approximately equal particle sizes as indicated by the arrow “D”.

The sketch of FIG. 14b shows a schematic view of the two SiO₂ particles 41a, 41b that have joined together as a result of a sintering operation and the dopant-rich glass region 43 arising from the dopant layer 42 by sintering, which surrounds the SiO₂ particles 41a, 41b and also extends between them. The glass region 43 does not represent a separate phase, but it differs from the region of the former SiO₂ particles 41a, 41b only by a comparatively higher proportion of dopant. As a result of diffusion during the sintering process, the dopant which was originally concentrated on the particle surfaces has been distributed throughout the quartz glass, but still displays a maximum concentration in the region of the former surfaces.

This is shown schematically by the diagram of FIG. 14c, in which the dopant concentration “C” determined by spatially resolved analysis is plotted against the position coordinate “x”, the lateral path of which is indicated by the directional arrow 44. Maxima 45 of the dopant concentration are determined in the glass regions 43. The centre-to-centre distances A1 and A2 of the maxima 45 are at most as large as the initial average particle size D of the SiO₂ particles 41a, 41b (i.e. for example smaller than 30 μm for SiO₂ particles with an average particle size of less than 30 μm). This is considered here to be a measure of a high microhomogeneity of the dopant distribution, which contributes to a high dry-etch resistance, low particle formation and uniform etch removal.

The component according to the invention can be produced by the method of the invention as described above.

With regard to a high homogeneity of the dopant distribution, it has proved advantageous if the dopant or dopants are present in a total dopant concentration ranging from 0.1 wt. % to 5 wt. %, preferably in a total dopant concentration ranging from 0.5 to 3 wt. %.

With total dopant concentrations of less than 0.1 wt. % the effect on the improvement in dry-etch resistance declines, and with total dopant concentrations of more than 5 wt. % it proves increasingly difficult to suppress undesirable bubble formation.

The doped quartz glass preferably contains at least one dopant compound with a dopant selected from the group consisting of: Al, Sm, Eu, Yb, Pm, Pr, Nd, Ce, Tb, Gd, Ba, Mg, Y, Tm, Dy, Ho, Er, Cd, Co, Cr, Cs, Zr, In, Cu, Fe, Bi, Ga and Ti. These metals, which are generally present in quartz glass as oxidic compounds, are capable of reacting with fluorine to form a fluoride compound, the fluoride compound having a boiling point higher than that of SiF₄.

With regard to a high dry-etch resistance, an embodiment of the quartz glass component in which aluminium is the dopant and Al₂O₃ the dopant compound has proved particularly suitable, the total dopant concentration in this case preferably ranging from 0.5 to 3 wt. %.

Impurities in the quartz glass can have a negative effect on dry-etch resistance. At least the SiO₂ portion of the doped quartz glass is therefore made from synthetically produced SiO₂ raw materials. Synthetically produced SiO₂ raw materials are distinguished by high purity.

### Definitions and Test Methods

Individual terms from the above description will be additionally defined below. The definitions are part of the description of the invention. In the event of a discrepancy between one of the following definitions and the rest of the description, the statements made in the description are definitive.

### Quartz Glass

Quartz glass here is understood to be high-silica glass with an SiO₂ content of at least 90 mole %.

### Doping

The doping consists of one or more dopants. The “dopant” is a substance which is added to the glass intentionally in order to achieve desired properties.

The dopant (e.g. ytterbium; Yb) is usually present in quartz glass not in elemental form but as a compound, e.g. as an oxidic compound. Where appropriate, concentration figures relating to the dopant are based on SiO₂ and the molar concentration of the dopant in the form of the relevant compound in its highest oxidation stage (e.g. Yb₂O₃). The determination of the quantity of a starting substance to be used for the dopant in a non-oxidic form (e.g. YbCl₃) takes into account the ratio of the respective molar weights of the starting substance in the non-oxidic form and of the final dopant in its oxidic form.

### Slip—Dispersion

The term “slip” is used for a dispersion containing solid SiO₂ particles in a liquid. Water that has been purified by distillation or deionisation can be used as the liquid, to minimise the content of impurities.

### Particle Size and Particle Size Distribution

Particle size and particle size distribution of the SiO₂ particles are characterised using the D₅₀ values. These values are taken from particle size distribution curves, which show the cumulative volume of the SiO₂ particles as a function of particle size. Particle size distributions are often characterised using the relevant D₁₀, D₅₀ and D₉₀ values. The D₁₀ value characterises that particle size where 10% of the cumulative volume of the SiO₂ particles are smaller, and similarly the D₅₀ value and the D₉₀ value characterise those particle sizes where 50% and 90% respectively of the cumulative volumes of the SiO₂ particles are smaller. The particle size distribution is determined by light scattering and laser diffraction spectroscopy in accordance with ISO 13320.

### Granular Material

A distinction can be made between layering granulation and pressure granulation and, in terms of processing, between wet and dry granulating methods. Known methods are rolling granulation in a pan granulator, spray granulation, frost granulation, centrifugal atomisation, fluidised-bed granulation, granulating methods using a granulating mill, compaction, roller presses, briquetting, flake production or extrusion.

During granulation, discrete, relatively large agglomerates, which are referred to here as “SiO₂ granular material particles” or “granular material particles” for short, are formed by aggregations of the SiO₂ primary particles. In their totality, the granular particles form an “SiO₂ granular material”.

### Granular Material Purification

By a thermochemical “purification” of the granular particles, the content of impurities is reduced. The main impurities are OH groups, carbon-containing compounds, transition metals, alkali metals and alkaline earth metals originating from the feed material or introduced as a result of the processing operation. The purification comprises a treatment at high temperature (>800° C.) under a chlorine-containing, fluorine-containing and/or oxygen-containing atmosphere.

### Sintering/Fusing

“Sintering” here refers to a treatment at an elevated temperature of more than 1100° C., which causes a vitrification of the granular particles and the formation of the doped, transparent quartz glass component while maintaining a certain long-range order, without the granular particles being completely melted (eliminating long-range order).

During “fusing”, the granular particles are heated to a very high temperature of more than 1800° C. to form a viscous quartz glass melt.

### Surface Roughness

The surface roughness is measured using a profilometer (VEECO Dektak 8). The average roughness depth Rₐ is determined from the measured values in accordance with DIN 4768 (2010).

### Measurement of Microhomogeneity

The microhomogeneity—defined as homogeneity of the dopant distribution in the micrometre range—is determined indirectly based on the surface roughness after carrying out a standard dry-etching procedure. Alternatively or in addition, the dopant concentration profile is determined by energy-dispersive X-ray spectroscopy (EDX).

### Measurement of Tapped Density

The term “tapped density” refers to the density produced after mechanical compaction of the powder or granular material, e.g. by vibrating the container. It is determined in accordance with DIN/ISO 787 Part 11.

### EXEMPLARY EMBODIMENT

The invention will be explained in more detail below with the aid of an exemplary embodiment and a drawing. The individual figures show the following:

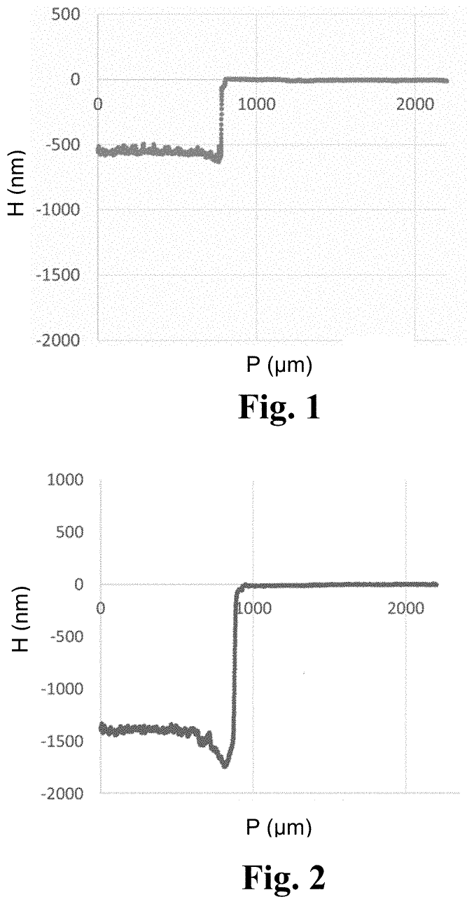

FIG. 1 an etch profile in a sample made of an Al₂O₃-doped quartz glass according to the invention after carrying out a standard dry-etching program in a plasma-etching reactor,

FIG. 2 an etch profile in a reference sample made of pure, undoped quartz glass (reference sample) after carrying out the standard dry-etching program,

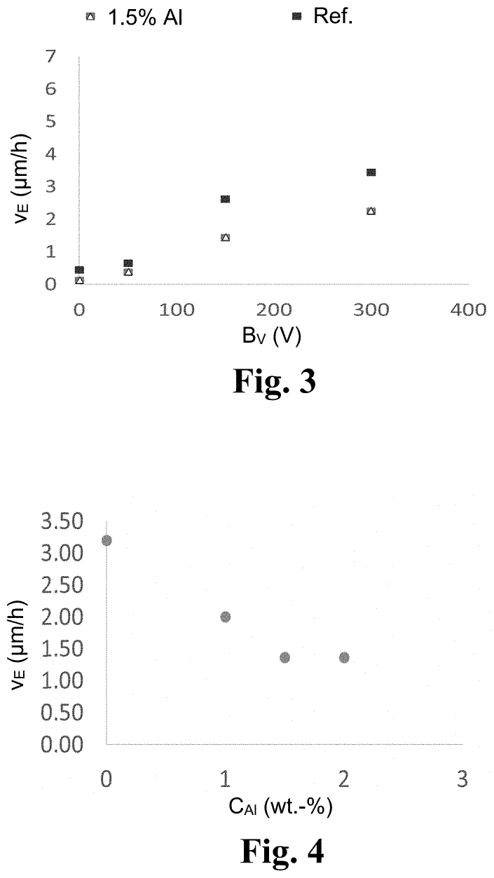

FIG. 3 a graph showing the erosion rate as a function of the acceleration voltage of the plasma-etching reactor,

FIG. 4 a graph showing the erosion rate as a function of the Al₂O₃ concentration of the quartz glass,

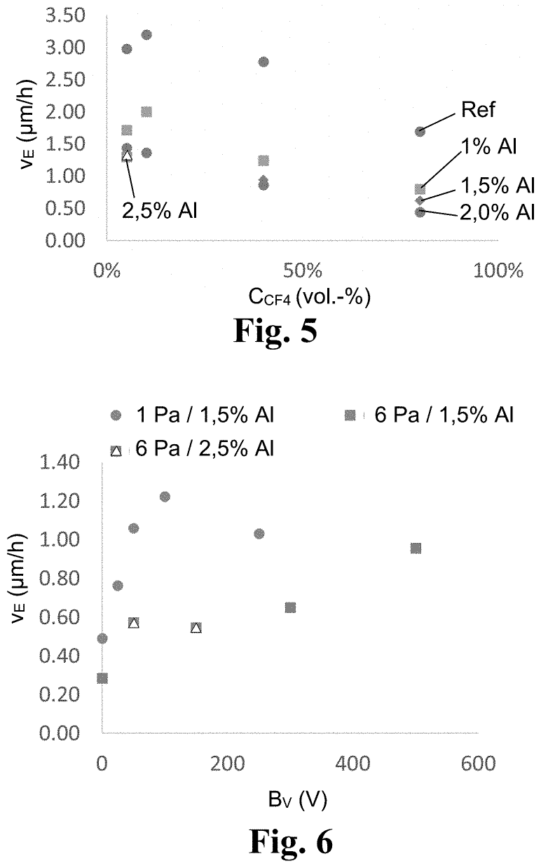

FIG. 5 a graph showing the erosion rate as a function of the CF₄ concentration in the etching gas of the plasma-etching reactor,

FIG. 6 a graph showing the relative erosion rate as a function of the internal pressure in the etching chamber of the plasma-etching reactor for various samples,

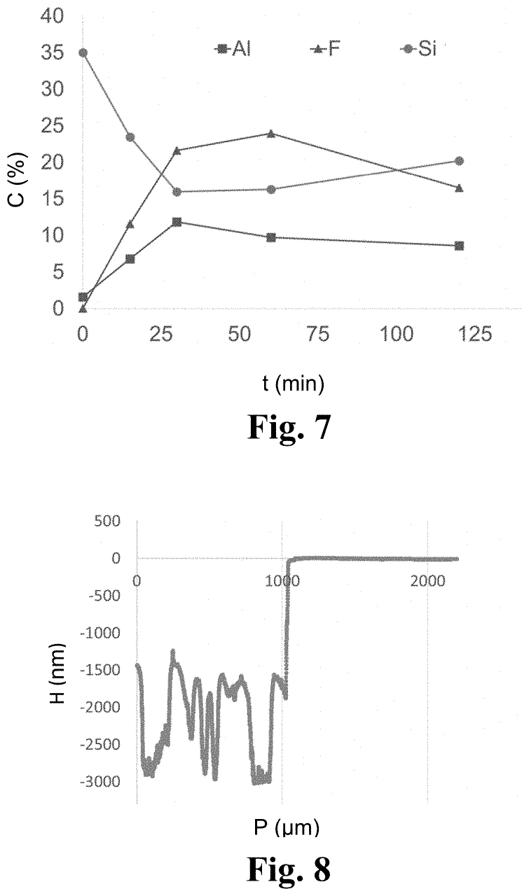

FIG. 7 a graph showing the chemical occupancy of the surface of etched samples as a function of the etching period,

FIG. 8 an etch profile in a comparative sample made of an Al₂O₃-doped quartz glass after carrying out the standard dry-etching program,

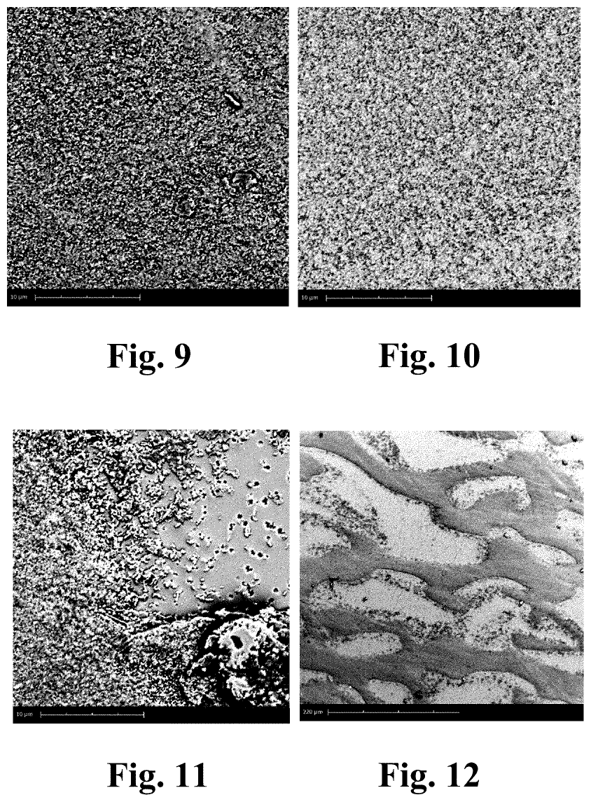

FIG. 9 a scanning electron microscope image of a sample surface made of pure, undoped quartz glass (reference sample) after carrying out the standard dry-etching program in the plasma-etching reactor,

FIG. 10 a scanning electron microscope image of a sample surface made of Al₂O₃-doped quartz glass according to the invention after carrying out the standard dry-etching program in the plasma-etching reactor,

FIG. 11 a scanning electron microscope image of the surface in a comparative sample made of an Al₂O₃-doped quartz glass after carrying out the standard dry-etching program,

FIG. 12 the surface of the comparative sample of FIG. 11 in higher magnification,

FIG. 13 an embodiment of a reactor for carrying out a plasma-assisted manufacturing process, and in particular for carrying out dry-etching procedures, in a schematic diagram,

FIG. 14 a sketch explaining the method of determining a lateral dopant concentration profile,

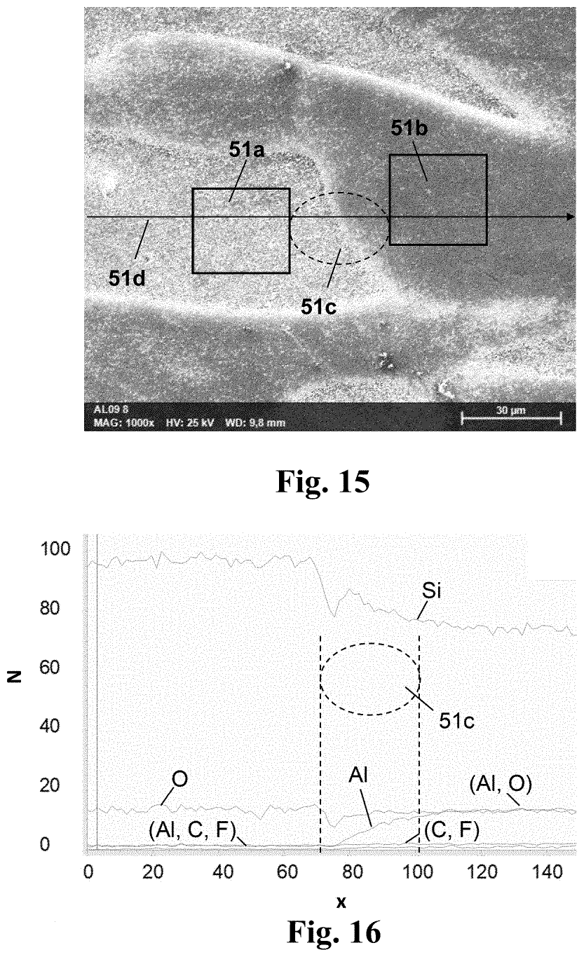

FIG. 15 an image produced by energy-dispersive X-ray spectroscopy (EDX) of the surface of a test sample made of a flame-fused and Al₂O₃-doped quartz glass after carrying out the standard dry-etching program in the plasma reactor, and

FIG. 16 a graph showing the lateral, two-dimensional relative concentration distribution of the elements, Si, Al, C, oxygen (O) and fluorine (F) within the test sample along the measuring line drawn in on FIG. 15.

### Production of a Doped Quartz Glass Component

In a conventional soot deposition process, using octamethylcyclotetrasiloxane (OMCTS) as a starting substance, SiO₂ primary particles with average particle sizes of less than 100 nm were synthesised, which agglomerated together in a reaction zone to form secondary particles in the form of more or less spherical aggregates or agglomerates. These secondary particles, which were made up of different numbers of primary particles and had an approximate average particle size (D₅₀ value) of less than 10 μm, will also be referred to below as “SiO₂ particles”. Table 1 gives typical properties of the SiO₂ particles.

TABLE 1

| Tapped density | 0.03-0.05 | m²/g |
|---|---|---|
| Residual moisture | 0.02-1.0% | |
| Primary particle size | 94 | nm |
| D₁₀ | 3.9 +/− 0.38 | μm |
| D₅₀ | 9.4 +/− 0.67 | μm |
| D₉₀ | 25.6 +/− 10.4 | μm |

A slip was prepared, composed of these discrete, synthetically produced SiO₂ particles with an average particle size (D₅₀ value) of around 10 μm in ultrapure water.

By adding a concentrated ammonia solution, the pH value was adjusted to 14. The alkaline suspension was homogenised and filtered.

In addition, an aqueous doping solution of AlCl₃ in ultrapure water was produced, homogenised and likewise filtered.

The doping solution was supplied in the form of a spray mist to the slip, which was agitated by stirring. To produce the spray mist, the doping solution was atomised using a spray nozzle, the operating pressure being set at 2 bar and the flow rate at 0.8 I/h. The spray mist thus produced contained drops having an average diameter of between 10 μm and 40 μm. Owing to the high pH of the slip, an immediate precipitation of the dopant occurred in the form of Al(OH)₃. The solid particles adsorbed on the existing surfaces of the SiO₂ particles and were thereby immobilised, such that a coagulation of the solid particles or a sedimentation was prevented. The slip to which the dopant had been added was then homogenised by stirring for a further 2 hours. With this procedure, it was ensured that an optimally homogeneously doped SiO₂ slip was obtained.

The doped SiO₂ slip was frozen and further processed by frost granulation to form a granular material. The granular material slurry obtained after thawing was washed multiple times with ultrapure water and the excess water was decanted off each time.

The granular material slurry that had been freed from ammonia and purified was then dried at a temperature of around 400° C. The dried granular material typically had grain sizes ranging from 300 μm to 600 μm. It was welded into a plastic mould and pressed isostatically at 400 bar to form a granular material blank.

The granular material blank was treated in a chlorine-containing atmosphere at approximately 900° C. for approximately 8 hours. As a result, impurities were removed from the blank and the hydroxyl group content was reduced to approximately 3 ppm by weight.

The purified granular material blank had a cylindrical shape with a diameter of 30 mm and a length of 100 mm. Its average density was approximately 45% of the density of the doped quartz glass. It was pre-sintered by heating to a temperature of 1550° C. in a vacuum furnace and then sintered by gas pressure sintering under argon to form a cylinder of Al₂O₃-doped, transparent quartz glass. The gas pressure sintering process was performed in a gas pressure sintering furnace with an evacuable sintering mould made of graphite. The interior of the sintering mould was of cylindrical configuration and was delimited by a base and a side wall having an annular cross-section.

In this way, glass samples with average Al₂O₃ concentrations of between 1 and 2.7 wt. % were prepared. For carrying out measurements, plates with a thickness of approximately 1 mm and lateral dimensions of between 13 mm×13 mm and 28 mm×28 mm were cut therefrom and polished.

### Plasma-Etching Tests

Dry-etching tests were performed on samples of the Al₂O₃-doped quartz glass and a sample of commercially available quartz glass. For this purpose, a dry-etching reactor was employed, as explained above with the aid of FIG. 13.

The surface[s] of the samples to be measured were polished, such that they had an initial average roughness (Rₐ value) of approximately 3 nm, and were partially masked with polyimide tape. The samples were then treated for a period of 0.5 hours to 3 hours together with a reference sample made of commercially available, non-doped quartz glass of high homogeneity (“Spectrosil 2000” from Heraeus Quarzglas GmbH & Co. KG) in order to measure the etch stage (also referred to below as the “erosion stage”) and the surface roughness.

### Surface Profile and Erosion Rates

The relative erosion rate of the aluminium-doped samples compared with the reference sample varied as a function of the aluminium oxide concentration of the sample, the chamber pressure, the inductive power coupled to the plasma, and the bias voltage that was applied.

The graph of FIG. 2 shows the surface profile thus obtained for the reference sample of undoped quartz glass after carrying out the standard dry-etching procedure explained above over a total etching period of 1 h. The etch depth H (in nm) is plotted against the position coordinate P (in μm). On the right-hand side of the graph is the masked surface region of the sample; on the left-hand side is the etched and roughened region of the sample. This shows that a pronounced erosion stage has formed, with a height of approximately 1360 nm; the Rₐ value of the eroded surface was approximately 15 nm.

As a comparison, FIG. 1 shows the profile curve of a sample doped with 2.7 wt. % Al₂O₃, which was treated together with the reference sample. This sample shows an erosion stage of approximately 560 nm and thus an erosion rate approximately 59% lower than that of the reference sample. The Rₐ value of the eroded surface was approximately 10 nm, and therefore was even somewhat lower than for the reference sample.

The graph of FIG. 3 shows an example of the dependence of the erosion rates on bias voltage for a sample of quartz glass doped with 1.5% Al₂O₃, compared with the reference sample. Here, the erosion rate v_{E} (in μm/h) is plotted against the bias voltage By in (V). It was shown that, over the entire bias voltage range between 0 V and 300 V, the erosion rate of the aluminium-doped sample was significantly lower than that of the reference sample. At higher bias voltages, however, the relative difference between the erosion rates decreased. This is interpreted as follows.

During the plasma treatment, fluorine from the fluorocarbon plasma reacts with aluminium in the Al₂O₃-doped quartz glass, resulting in a surface layer on the glass which contains aluminium fluoride as well as silicon dioxide. In addition, the fluorine reacts with the silicon in the glass and forms silicon fluoride (SiF₄). While SiF₄ is gaseous at ambient temperature and therefore escapes from the surface immediately, AlF₃ is solid and remains on the surface, thereby preventing further erosion and reducing the erosion rate. At higher bias voltages, the energy of the ions (principally argon ions) reaching the glass surface is higher and leads to increased sputtering of the surface, including the sputtering of the AlF₃ formed by chemical reaction. Thus, at higher bias voltages the erosion rate of the aluminium-doped sample approaches that of pure quartz glass.

The graph in FIG. 4 shows the dependence of the erosion rate v_{E} (in μm/h) on the initial Al₂O₃ concentration C_{Al} (in wt. %). The erosion rates were determined for the reference sample (C_{Al}=0) and for samples with weighed Al₂O₃ concentrations of 1, 1.5 and 2 wt. %. The following etch parameters were used: plasma gas composition: 90 vol. % argon and 10 vol. % CF₄,

induction power: 600 W,
bias voltage (DC bias): 100 V,
chamber pressure: 2.8 Pa.

It is shown that the erosion rate decreases with the aluminium oxide concentration and, in the sample with the highest concentration (C_{Al}=2 wt. %), it falls to approximately 40% based on the erosion rate of the reference sample.

The graph of FIG. 5 shows the dependence of the erosion rate v_{E} (in μm/h) on the plasma gas composition, or more precisely on the proportion of CF₄ in the plasma gas C_{CF4} (in vol. %; the rest is argon) and on the dopant concentration (for Al₂O concentrations of 0; 1.0; 1.5; 2.0 and 2.5 wt. %) for the following etch parameters:

induction power: 600 W,
bias voltage: 100 V DC,
chamber pressure: 2.8 Pa.

The highest erosion rate is obtained for a composition of the plasma gas with approximately 10 vol. % CF₄ and 90 vol. % argon. The relative erosion rates of the aluminium-doped quartz glasses compared with the reference sample were lowest for the highest CF₄ content in the test, of 80 vol. %. This is in line with the theory that the erosion rate reduction is most significant when the plasma is rich in fluorine which is available for a chemical reaction with the aluminium in the glass, to form a masking of dense AlF₃, and that the reduction in the erosion rate is less pronounced when the plasma is rich in argon, which increases the sputtering rate of the AlF₃ on the sample surface.

FIG. 6 shows the dependence of the erosion rate v_{E} (in μm/h) on the chamber pressure for quartz glass samples doped with 1.5 wt. % and with 2.5 wt. % Al₂O₃. In the graph, the development of the relative erosion rate (in μm/h—based on the erosion rate of the reference sample) is plotted against the bias voltage By (in V) for different chamber pressures (1 Pa and 6 Pa). At sufficiently low pressures and high bias voltages, no significant difference in the erosion rates is shown between the aluminium-doped glasses and the reference sample. At a low chamber pressure of 1 Pa, the sample with the weighed Al₂O₃ concentration of 1.5 wt. % shows a reduced erosion rate effect only at bias voltages of less than approximately 50 V. At a high chamber pressure of 6 Pa, however, both of the samples with the weighed Al₂O₃ concentrations of 1.5 wt. % and 2.5 wt. % show a lower relative erosion rate up to bias voltages of approximately 400 V. Thus, the effect of the doping on the etch rate depends on both the bias voltage and the chamber pressure. At lower chamber pressures, it is assumed that the flow of ions to the sample surface is higher, which would lead to a more intense sputtering of the aluminium fluoride masking. Thus, at lower chamber pressures the masking effect, which leads to a reduced erosion rate, would be less pronounced than at high chamber pressures.

To support the theory that the reduction in the erosion rate of the aluminium-doped samples is attributable to an AlF₃ enrichment of the eroded surface, X-ray photoelectron spectroscopy measurements were performed on the eroded surfaces. A result of these measurements is shown by the graph of FIG. 7, from which the development of the relative molar concentrations C (mole %) of aluminium, fluorine and silicon can be seen for a test sample with a weighed Al₂O₃ content of 0.6 wt. % over the etching period t (in min). The measurements started only after a preliminary 10-minute sputtering of the surface to remove impurities (e.g. from carbon). The samples were treated with the plasma gas for 15 minutes, 30 minutes, 60 minutes and 120 minutes. A separate sample was produced for each measurement period. It was shown that the surface was enriched with aluminium and fluoride in the course of the plasma treatment and an approximately constant concentration was reached after approximately 30 minutes. The initial aluminium (oxide) concentration of approx. 1.6 mole % was increased to approximately 10 mole % by the plasma treatment, and the fluoride concentration rose to approximately 20 mole %. The Al:F ratio of 1:2 does not quite correspond to the molar ratio of 1:3 that would be expected of a pure AlF₃ species, but shows that a chemical reaction took place between Al and F and an enrichment of these two species occurred on the surface. At the same time, the relative molar concentration of silicon was reduced, which can be explained by the enrichment with Al and F and by the chemical reaction of fluorine with silicon, resulting in volatile SiF₄.

It has been shown that the quartz glass prepared by the method according to the invention has, after the plasma-etching treatment, a surface with a roughness that is significantly lower than the surface roughness of aluminium-doped samples produced according to the prior art. For example, a sample doped with approximately 0.9 wt. % Al₂O₃ was prepared by the method described in the above-mentioned US 2008/0066497 A1 (melting a powder mixture and depositing molten glass particles on a carrier by the Verneuil method). The treatment of this quartz glass with plasma conditions similar to those for the samples described with the aid of FIGS. 1 and 2 led to a significantly rougher surface, as shown by the erosion profile in FIG. 8 (etch depth H (in nm) and position coordinate P (in μm)). The unmasked part of the sample (left-hand side) shows valleys with a depth of more than 1000 nm and a surface roughness with an Rₐ value of 160 nm. This is a measure of the marked change in the surface over the course of the lifetime of the component as a result of etch removal, which makes it difficult to take proper and reproducible account of the parameter of “surface roughness” with regard to particle generation in semiconductor fabrication.

In Table 2, the Rₐ values of the etched surfaces are compiled for the reference quartz glass as described with the aid of FIG. 2, for the example according to the invention as described with the aid of FIG. 1, and for the comparative example as described with the aid of FIG. 8.

TABLE 2

| | | | Comparative |
|---|---|---|---|
| | Reference | Example | example |
| | (FIG. 2) | (FIG. 1) | (FIG. 8) |
| Roughness depth Rₐ (nm) | 15 | 10 | 260 |
| Relative change in | 1 | 0.7 | 17 |
| roughness depth Rₐ based | | | |
| on reference Rₐ | | | |

After the dry-etching treatment, the surface in the comparative example displays an average roughness depth Rₐ which is higher by a factor of 17 compared with the surface of the undoped but highly homogeneous reference quartz glass. In comparison, after the dry-etching treatment, the surface of the doped quartz glass according to the invention displays an average roughness depth Rₐ which is lower by a factor of 0.7 compared with the reference quartz glass.

A plurality of etching tests show that, regardless of the specific parameters of the dry-etching treatment, the ratio of the average roughness depths of doped quartz glass according to the invention and reference quartz glass is typically and preferably in the range of 0.5 and 3 and particularly preferably in the range of 0.7 to 2 for test samples treated at the same time.

FIG. 9 is an SEM image of the surface of the reference sample after a standard dry-etching procedure in a 10,000× magnification. The lateral distance between peaks and valleys of the roughness profile is approximately 1 μm.

FIG. 10 likewise shows a 10,000× magnification of the surface of a plasma-treated test sample made of quartz glass according to the invention, which is doped with 0.5 wt. % Al₂O₃. The lateral distance between peaks and valleys of the roughness profile is in the same range as for the reference sample.

The SEM image of FIG. 11 likewise shows a 10,000× magnification of the surface of a comparative sample made of quartz glass doped with 0.9 wt. % Al₂O₃ which has been plasma-treated with the aid of the standard dry-etching procedure and produced with the aid of the Verneuil method as in US 2008/0066497 A1. It can be seen that partial regions of the surface are similar to the surfaces shown in FIGS. 9 and 10 but that other partial regions have a different structure, which emphasises the greater inhomogeneity of a plasma-treated sample prepared in this way.

FIG. 12 is an image of the comparative sample at a lower magnification of approximately 610×, from which it can be seen that the lateral distances between valleys and peaks of the surface profile are approximately 200 μm on average.

In summary, these investigations show that a doped quartz glass produced by the production method described above using a doped slip made of pyrogenically produced SiO₂ particles leads to at least a twofold reduction in the plasma erosion rate if the plasma conditions are such that the physical sputtering of the surface is minimised. In particular, the bias voltage on the sample should not be too high, and a chamber pressure greater than approximately 2 Pa has a favourable effect.

FIG. 15 shows measurement results for the chemical microhomogeneity of a flame-fused, aluminium-doped quartz glass after carrying out the standard dry-etching treatment in a plasma reactor. The flame fusion takes place by melting a powder mixture and depositing the molten glass particles on a carrier by the Verneuil method. The macroscopic measurement of the aluminium concentration in the test sample before the dry-etching treatment gave approximately 0.7 at. %.

After the dry-etching treatment, microscopic measurements of the chemical composition were performed by energy-dispersive X-ray spectroscopy (EDX). The dark regions of the image correspond to the topographic peaks determined profilometrically in roughness measurements, and the light regions to the topographic valleys. In the light region 51a, EDX analysis gives the following chemical composition (in at. %):

oxygen: 52.3%, silicon: 26.0%, carbon: 20.7%.

The light region 51b thus contains aluminium in a negligible quantity if at all. For the dark region 51b, the following chemical composition is obtained (in at. %):

oxygen: 46.5%, carbon: 26.9%, silicon: 20.0%, aluminium: 3.7%, fluorine: 2.8%.

The dark region 51a thus displays an aluminium enrichment caused by the plasma erosion process. A transition region between the light and dark regions (51a, 51b) having a longitudinal extension of approximately 30 μm is symbolised in FIG. 15 by an ellipsis with the reference sign 51c, and a measurement line for the line scan of FIG. 16 by the reference sign 51d.

In the line scan of FIG. 16, the pulse number “N” of the EDX elemental concentration measurements (in relative units) is plotted on the y axis against the position coordinate “x” along the measurement line 51d drawn in on FIG. 15. The concentration profiles for Si, Al, O, C, and F are labelled with the relevant chemical element symbols. A plurality of element symbols in brackets, such as (Al, C, F), (C, F) and (Al, O) show profile regions in which the profiles of the elements mentioned in each case overlap. It is apparent that, in the transition region 51c, the aluminium concentration increases significantly over a distance of approximately 30 μm. This test sample displays inadequate microhomogeneity accompanied by low dry-etch resistance. It is proof of the fact that, in the production of doped quartz glass for use in plasma-assisted manufacturing processes, the manufacturing method used plays a crucial part in adjusting the microhomogeneity.

1-12. (canceled)

13. A doped quartz glass component for use in a plasma-assisted semiconductor manufacturing process containing at least one dopant that is capable of reacting with fluorine to form a fluoride compound, wherein the fluoride compound has a boiling point higher than that of SiF₄, and characterized in that the doped quartz glass has a microhomogeneity defined by (a) a surface roughness with an Rₐ value of less than 20 nm after the surface has been subjected to a dry-etching procedure as specified in the description, or (b) a dopant distribution with a lateral concentration profile in which maxima of the dopant concentration are at an average distance apart of less than 30 μm.

14. The component according to claim 13, characterized in that the surface has an Rₐ value of less than 15 nm or the maxima of the dopant concentration are at an average distance apart of less than 20 μm.

15. The component according to claim 13, characterized in that the dopant or dopants are present in a total dopant concentration ranging from 0.1 wt. % to 5 wt. %.

16. The component according to claim 13, characterized in that the dopant or dopants are present in a total dopant concentration ranging from 0.5 to 3 wt. %.

17. The component according to claim 13, characterized in that the doped quartz glass contains at least one dopant compound with a dopant selected from the group consisting of: Al, Sm, Eu, Yb, Pm, Pr, Nd, Ce, Tb, Gd, Ba, Mg, Y, Tm, Dy, Ho, Er, Cd, Co, Cr, Cs, Zr, In, Cu, Fe, Bi, Ga and Ti.

18. The component according to claim 14, characterized in that aluminium is the dopant and Al₂O₃ is the dopant compound, and in that the total dopant concentration is in the range of 0.5 to 3 wt. %.

19. The component according to claim 13, characterized in that the doped quartz glass is made from synthetically produced SiO₂ raw materials.

20. A method of producing a doped quartz glass component according to claim 13, for use in a plasma-assisted manufacturing process, comprising the following method steps:
(a) providing a slip containing SiO₂ particles in an aqueous liquid,
(b) providing a doping solution containing a solvent and at least one dopant in dissolved form,
(c) bringing together doping solution and slip to form a dispersion, in which a solid containing the dopant is precipitated,
(d) drying the dispersion to form granular particles containing SiO₂ and the dopant, and
(e) sintering or fusing the granular particles to form the doped quartz glass component,
characterized in that the SiO₂ particles in the slip are aggregates or agglomerates of SiO₂ primary particles and have an average particle size of less than 30 μm.

21. The method according to claim 20, characterized in that for bringing together the doping solution and slip, the doping solution is atomised to form a spray mist and this is supplied to the dispersion.

22. The method according to claim 20, characterized in that when the doping solution and slip are brought together, the latter is kept in motion.

23. The method according to claim 20, characterized in that before the doping solution and slip are brought together, the latter is adjusted to a pH value greater than 12.

24. The method according to claim 20, characterized in that the SiO₂ primary particles are produced pyrogenically and preferably have an average particle size of less than 100 nm.

25. The method according to claim 20, characterized in that the sintering of the granular particles takes place in a nitrogen-containing atmosphere by gas pressure sintering.
